(19) United States
(12) Patent Application Publication
(10) Pub. No.: US 2018/0314128 A1
(43) Pub. Date: Nov. 1, 2018

(54) OPTICAL MODULATOR WITH FOLDED CAPACITIVE LOADING SLOW-WAVE ELECTRODE

(71) Applicant: LaXense Inc., Walnut, CA (US)

(72) Inventors: Xiaochen Sun, Chino Hills, CA (US); Ningning Feng, Acadia, CA (US)

(73) Assignee: LaXense Inc., Walnut, CA (US)

(21) Appl. No.: 15/787,680

(22) Filed: Oct. 18, 2017

Related U.S. Application Data
(60) Provisional application No. 62/409,815, filed on Oct. 18, 2016.

(51) Int. Cl. G02F 1/225

(52) U.S. Cl. CPC G02F 1/225; G02F 2001/212

(57) ABSTRACT

An optical waveguide modulator device includes two optical waveguides forming a Mach-Zehnder interferometer structure and two co-planar waveguide (CPW) traveling-wave electrodes (TWEs). Each optical waveguide includes a plurality of segmented phase tuning sections (phasers). The segmented phasers are folded multiple times and the segments are perpendicular to the TWE electrodes. The phase of the optical signal passing through the optical waveguide is electrically tunable by electrical signals applied to the optical modulator device through the two CPW TWE electrodes. The lengths of the connecting sections between adjacent phaser segments are design such that the wave fronts of microwave and optical wave can be matched after each phaser segment. The CPW TWE electrodes are connected by a plurality of capacitive loading phaser segments, which can effectively reduce the characteristic impedance of the TWE electrodes.

### BACKGROUND OF THE INVENTION

### Field of the Invention

The invention relates to an optical waveguide modulator device. In particular, the invention relates to an optical waveguide modulator chip using folded capacitive loading slow-wave electrode to dramatically reduce chip size compared to commonly used optical waveguide modulator using traveling wave electrode.

### Description of the Related Art

Optical waveguide modulators are widely adopted in fiber-optic and on-board optical communication devices and systems. With exploding demands for more bandwidth and longer transmission reach by telecom infrastructures and datacenters for applications from social networks, cloud service, to big data analysis and high performance computing, optical communications and high speed optical devices have increasingly been adopted ubiquitously. Many of today's optical devices are based on optical chips fabricated by processes similar to those for making semiconductor and integrated circuit(IC) chips. Like in IC chips, chip size dictates both cost and use and a small chip size not only reduce cost proportionally but also offer opportunities to be used in more space-limited applications.

Optical waveguide modulator is one of the key components of many optical communication devices and systems. Most widely used type of high speed optical waveguide modulator chip uses electro-optic or carrier dispersion effect of the waveguide material to modulate the refractive index therefore the optical phase of the optical waveguide by applied electrical signal. And a Mach-Zehnder interferometer structure made of two such optical waveguides (called phaser) is used when optical intensity modulation is needed. Because the weak ability of changing refractive index by such electro-optic or carrier dispersion effect, long optical waveguides are used to accumulate the effect for sufficient refractive index change and a traveling wave electrode is generally required to apply electrical signal on such long optical waveguide to achieve high operating speed. The optical waveguide and the traveling wave electrode are usually designed in a straight line and in parallel with each other therefore the chip is usually quite long. For example, a Si-based Mach-Zehnder optical waveguide modulator requires 3-4 mm waveguide phaser for an extinction ratio above 3.5 dB demanded by low-requirement data center applications while the length needs double for other applications such as fiber-to-the-X and telecom. With adding other necessary structures the chip size is usually 6-10 mm in length which makes them costly and not suitable for certain applications with compact device requirement.

### SUMMARY

Accordingly, the present invention is directed to a device and related method that substantially obviate one or more of the problems due to limitations and disadvantages of the related art.

An object of the present invention is to provide optical waveguide modulator devices with significantly reduced overall chip size.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides an optical waveguide modulator device, which includes: two optical waveguides forming a Mach-Zehnder interferometer structure, and two co-planar waveguide (CPW) traveling-wave electrodes (TWEs); wherein each optical waveguide includes a plurality of segmented phase tuning sections (phasers), wherein a phase of the optical signal passing through the optical waveguide is electrically tunable by electrical signals applied to the optical modulator device through the two CPW TWE electrodes. In some embodiments, the segmented phasers are folded multiple times and the segments are perpendicular to the TWE electrodes.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a top view chip layout illustrating an optical waveguide modulator using folded capacitive loading slow-wave electrode according to an embodiment of the present invention.

FIG. 2 is an enlarged view of a portion of the chip layout shown in FIG. 1.

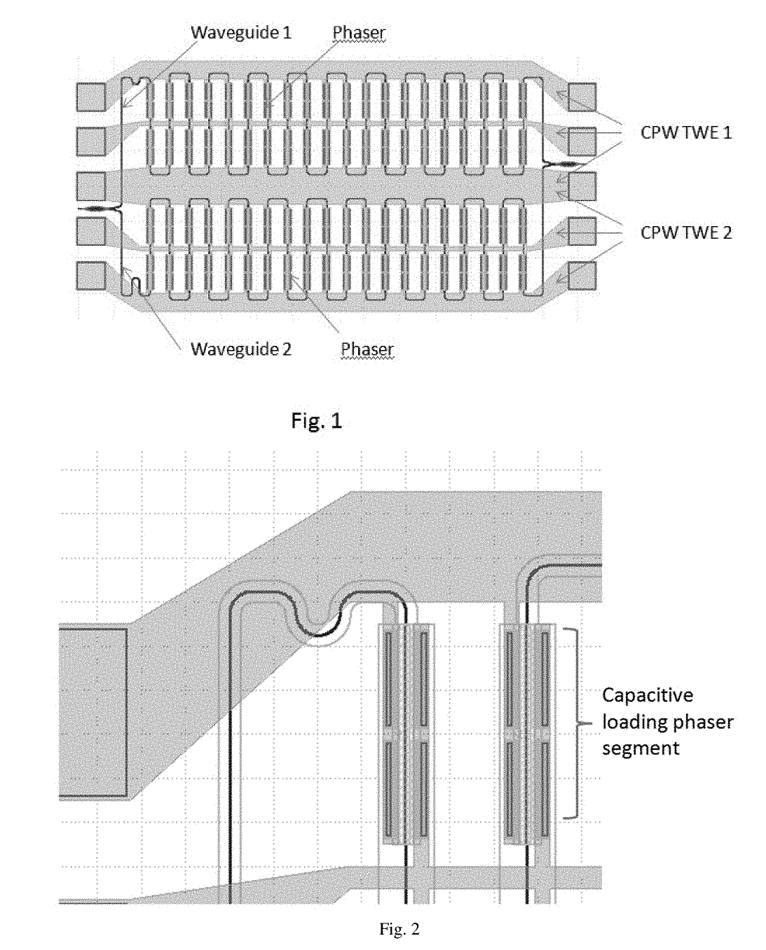

### DETAILED DESCRIPTION OF THE PREFERRED EMBODIMENTS

The optical waveguide modulator devices according to embodiments of the present invention significantly reduce the overall chip size to solve the issues presented in the background section.

One embodiment is an optical waveguide modulator device. The optical device is an optical chip which comprises two optical waveguides with segmented phasers and forms a Mach-Zehnder interferometer by combining the two waveguides at their both ends respectively, and two co-planar waveguide (CPW) traveling-wave electrodes (TWEs) for applying electrical signal hence modulating the two phaser waveguides respectively. The segmented phasers are folded multiple times and the segments are perpendicular to the electrode. It can dramatically shorten the total length of the traveling wave while keeping the required length of the phaser waveguide. There are some challenges for designing such an optical waveguide modulator with good high speed performance which requires both 50Ω impedance matching of the traveling wave electrode and velocity matching between the electrical microwave signal and optical wave carrier, both of which are much easier to meet in a common straight and parallel waveguide-electrode design. In the present embodiment, a much wider than usual signal-ground distance of the CPW TWE is used to intentionally increase its characteristic impedance to much higher than 50Ω which is subsequently reduced by capacitive loading phaser segments. In some embodiments, without limitation, the signal-ground distance of the CPW TWE is in the range of 100-150 μm, and the characteristic impedance is in the range of 80-120Ω. The high impedance introduces another problem that the velocity of the microwave becomes much slower (slow-wave) than that of the optical wave. Whereas the folded and perpendicularly aligned phaser waveguide already introduce more waveguide length in a segment than the CPW TWE length for the same segment. By designing a proper waveguide length at the connecting section between two adjacent phaser segments the wave front of microwave and optical wave can be matched after each segment. The length of the segment is designed to be much less than the microwave wavelength therefore the segmented CPW transmission line can still be approximately treated as a continuous TWE. In the design of each specific device, careful and rigorous microwave simulation should be performed to ensure all above requirements are met.

It will be apparent to those skilled in the art that various modification and variations can be made in the optical waveguide modulator device of the present invention without departing from the spirit or scope of the invention. Thus, it is intended that the present invention cover modifications and variations that come within the scope of the appended claims and their equivalents.

What is claimed is:

1. An optical waveguide modulator device comprising:
two optical waveguides forming a Mach-Zehnder interferometer structure; and
two co-planar waveguide (CPW) traveling-wave electrodes (TWEs);
wherein each optical waveguide includes a plurality of segmented phase tuning sections (phasers), wherein a phase of the optical signal passing through the optical waveguide is electrically tunable by electrical signals applied to the optical modulator device through the two CPW TWE electrodes.

2. The optical waveguide modulator device of claim 1, wherein the segmented phasers are folded multiple times and the segments are perpendicular to the TWE electrodes.

3. The optical waveguide modulator device of claim 1, wherein each of the two CPW TWE electrodes has a predefined signal-ground distance to increase its characteristic impedance to higher than 50Ω.

4. The optical waveguide modulator device of claim 1, wherein CPW TWE electrodes are connected by a plurality of capacitive loading phaser segments.

5. The optical waveguide modulator device of claim 1, wherein each optical waveguide further includes connecting sections between adjacent phaser segments, and wherein lengths of the connecting sections are configured to match wave fronts of microwave and optical wave after each phaser segment.
